(19) United States
(12) Patent Application Publication
(10) Pub. No.: US 2014/0355009 A1
(43) Pub. Date: Dec. 4, 2014

(54) MEASURING APPARATUS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KUEI-YANG LIN, Tu-Cheng (TW); MING-SHAN CAO, Shenzhen (CN); FAN-JIAN ZENG, Shenzhen (CN); BAO-FENG QU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/156,463

(22) Filed: Jan. 16, 2014

(30) Foreign Application Priority Data
May 28, 2013 (CN) 2013102038352

(51) Int. Cl. G01B 11/06

(52) U.S. Cl. CPC G01B 11/06
USPC 356/630

(57) ABSTRACT

A measuring apparatus includes a supporting column, a securing assembly, and a pair of measuring elements. The securing assembly is movably located on the supporting column at a predetermined height. The pair of measuring elements is secured on the securing assembly opposite to each other. The measuring elements receive a workpiece and transmit lasers to the workpiece respectively.

### BACKGROUND

1. Technical Field

The present disclosure relates to a measuring apparatus and especially relates to a measuring apparatus for measuring the thicknesses of workpieces.

2. Description of Relative Art

The thickness of workpieces needs to be measured when being manufactured. The workpiece is usually secured on a securing tool, and then is manually measured with a measuring tool. However, when a workpiece being measured has an irregular shape, it is difficult to take a manual measurement. Normally, errors will occur when the workpiece is manually measured, which will affect a measurement result. Moreover, manual measurements take longer times. Therefore, a improvement in the art which takes less time and improves the measurement result is needed.

### BRIEF DESCRIPTION OF THE DRAWINGS

Many aspects of the disclosure can be better understood with reference to the following figures. The components in the figures are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an exemplary embodiment of a measuring apparatus.

FIG. 2 is an exploded view of the measuring apparatus shown in FIG. 1.

FIG. 3 is an enlarged view of the measuring elements of the measuring apparatus shown in FIG. 1 with a workpiece.

FIG. 4 is an functional diagram of the measuring apparatus shown in FIG. 1 with a computer.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one”.

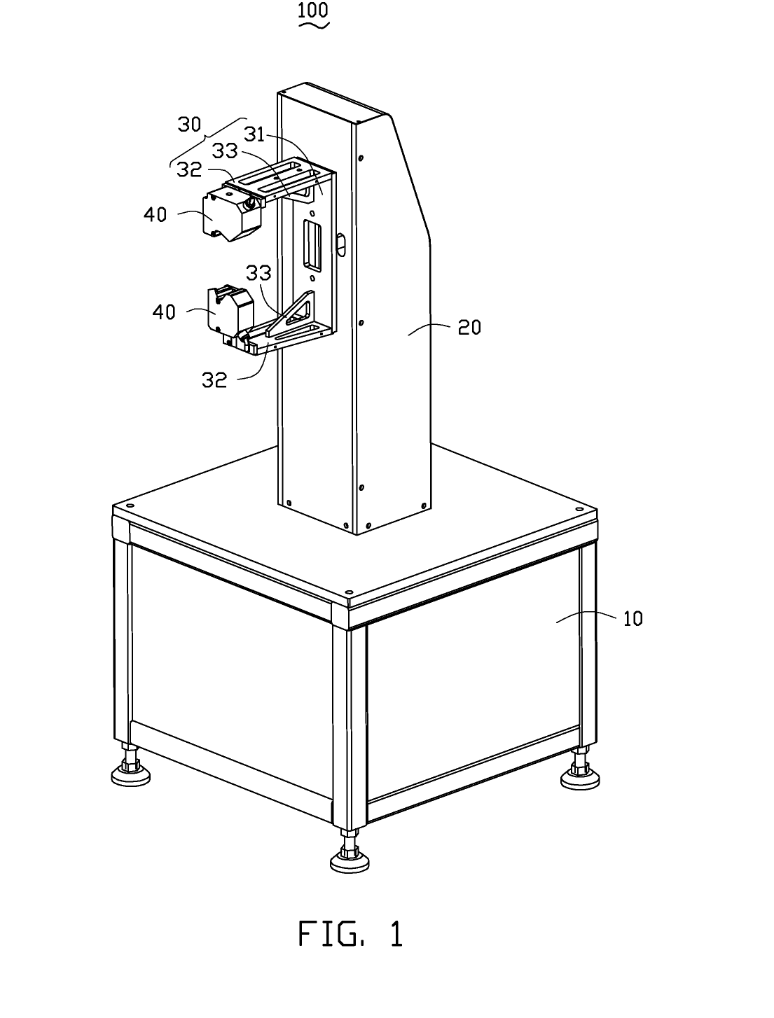

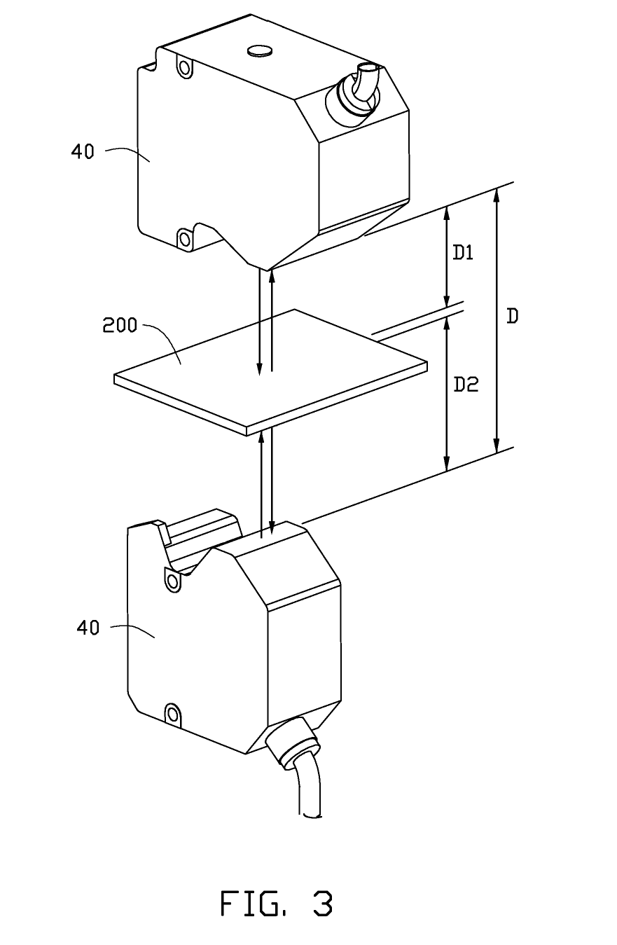

FIG. 1 and FIG. 3 show a measuring apparatus 100 according to one embodiment. The measuring apparatus 100 is used for measuring a thickness of a workpiece 200. The measuring apparatus 100 includes a control box 10, a supporting column 20, a securing assembly 30, and a pair of measuring elements 40. The measuring elements 40 are secured on the securing assembly 30. The securing assembly 30 is connected to the supporting column 20. The supporting column 20 is located on the control box 10.

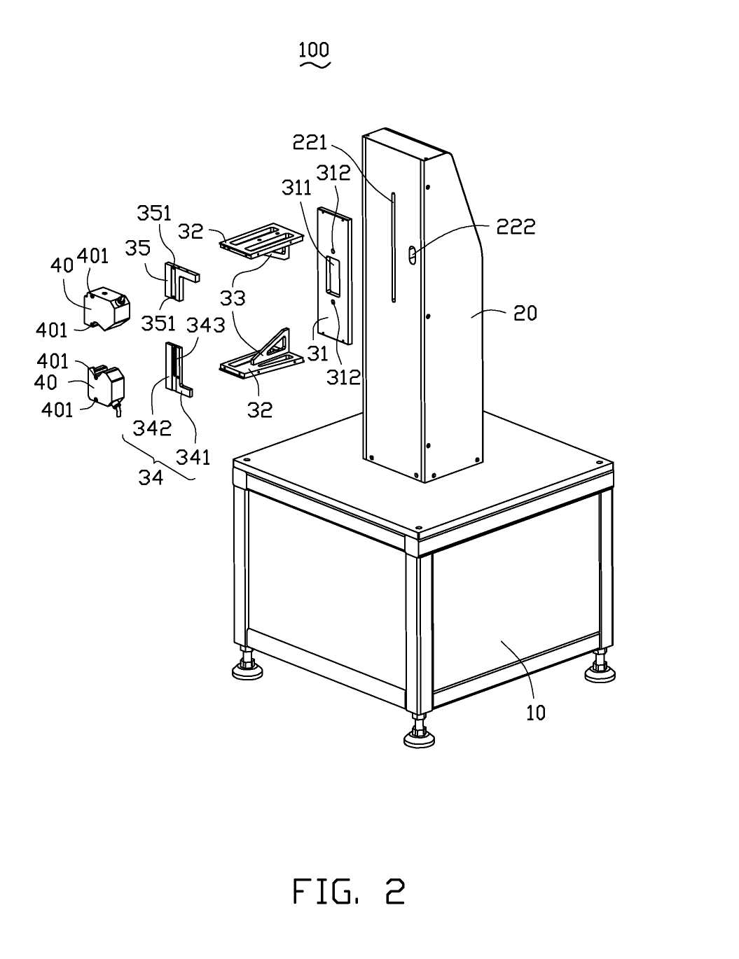

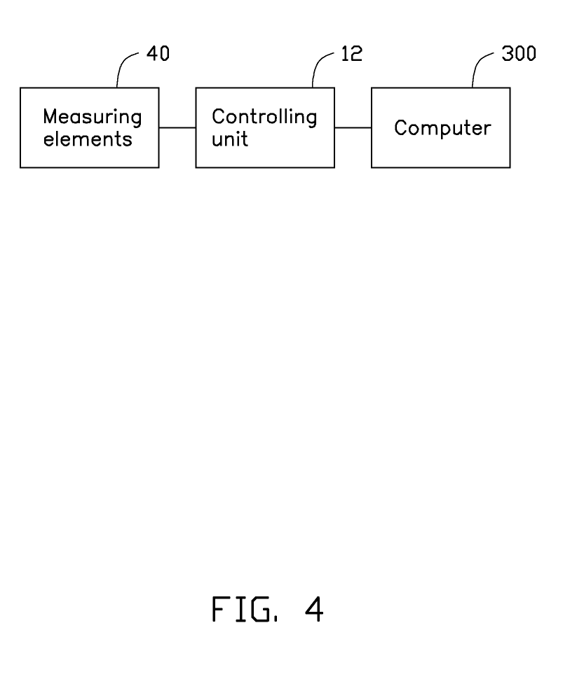

FIG. 2 and FIG. 4 show that the control box 10 includes a control unit 12 for controlling the measuring apparatus 100. The control unit 12 can be electrically connected to the measuring element 40 and a computer 300, thereby the computer 300 can calculate measuring data for the measuring apparatus 100.

The supporting column 20 is located on the control box 10. The supporting column 20 defines a mounting groove 221 and a hole 222 on one surface. The mounting groove 221 is defined longitudinally for mounting the securing assembly 30. The hole 222 is defined adjacent to the mounting groove 221 and receives cables (not shown) connecting the measuring elements 40 with the control unit 12, thus, the measuring elements 40 can be electrically connected to the control unit 12 in the control box 10 via the cables.

The securing assembly 30 includes a fixing board 31, a pair of connecting boards 32, a pair of strengthening boards 33, a first securing board 34, and a second securing board 35. The fixing board 31 is substantially rectangular and defines a slot 311 and a pair of mounting holes 312. The slot 311 is aligned with the mounting groove 221. The pair of mounting holes 312 are defined on opposite ends of the slot 311, each mounting hole 312 receives a fastener (not shown) which is also mounted to the mounting groove 221, thereby securing the fixing board 31 to the mounting groove 221. In one embodiment, the fastener can be a screw. Furthermore, the fixing board 31 can be moved relative to the mounting groove 221 to an appropriate position before being secured by the fasteners, thereby a height of the securing assembly 30 and the measuring elements 40 mounted thereon can be adjusted.

The pair of connecting boards 32 is connected to opposite ends of the fixing board 31 and extend perpendicularly from the fixing board 31. The connecting boards 32 are parallel. Each strengthening board 33 is connected to one of the connecting boards 32. Each strengthening board 33 is substantially a right-angle triangle and has a side supporting the connecting board 32 and another side abutting against the fixing board 31. The strengthening boards 33 are used for strengthening a connection of the connecting boards 32 and the fixing board 31.

The first securing board 34 is substantially an L-shaped board and includes a horizontal portion 341 and a longitudinal portion 342. The horizontal portion 341 is connected to one end of the connecting board 32 away from the fixing board 31. The longitudinal portion 342 is perpendicularly connected to the horizontal portion 341 and defines a securing groove 343. The securing groove 343 is defined longitudinally for securing one of the measuring elements 40. The second securing board 35 is substantially an L-shaped and defines a pair of securing holes 351 on opposite ends. One side of the second securing board 35 is connected to an end of the other connecting board 32. The second securing board 35 is opposite to the first securing board 34.

In one embodiment, the pair of measuring elements 40 includes a laser source element for emitting a laser and a laser detector for detecting a laser. Each measuring element 40 defines a pair of fixing holes 401 at its opposite ends. The fixing holes 401 of one measuring element 40 and the corresponding securing holes 351 receive corresponding fasteners, thereby securing one of the measuring elements 40 to the second securing board 35. The fixing holes 401 of the other measuring element 40 and the securing groove 343 receive fasteners, thereby securing the other measuring element 40 to the first securing board 34. In addition, the measuring element 40 can be moved relative to the securing groove 343 to an appropriate position before being secured by fasteners, thereby a distance between the pair of measuring elements 40 can be adjusted. In one embodiment, the fasteners can be screws.

When the measuring apparatus 100 begins to work, a robot (not shown) is provided to work cooperatively with the measuring apparatus 100. The robot positions a workpiece 200 in a space between the pair of measuring elements 40 and adjusts a portion of the workpiece 200 to be measured to be aligned with a portion of the measuring element 40 where lasers are transmitted. A total distance between the measuring elements 40 is defined as “D”. The laser source element of each the measuring element 40 emits a laser to the workpiece 200. The laser emitted by the measuring element 40 reaches a surface of the workpiece 200, then is reflected by the surface, and then is detected by the laser detector of the corresponding measuring element 40. The measuring element 40 records a time of reflection. Then the measuring element 40 transmits the recorded data to the computer 300 via the control unit 12 connected to the measuring element 40 and the computer 300. The computer 300 calculates a first distance between the measuring element 40 and the surface of the workpiece 200 according to the recorded time and a velocity of laser. The first distance between the measuring element 40 and the surface of the workpiece 200 is defined as “D₁”. With the same method, the other measuring element 40 measures a second distance of another surface of the workpiece 200. The second distance between the other measuring element 40 and another surface of the workpiece 200 is defined as “D₂”. A thickness of the workpiece 200 can be calculated by the total distance D minus the first distance D₁ and the second distance D₂.

It should be known that the distance first D₁ and the second distance D₂ are average results after measuring several times.

In other embodiments, when the workpiece 200 is transparent material or has a mirror surface, the surface of the workpiece 200 is covered by non-reflective materials before being measured, thereby ensuring the measuring results.

The measuring apparatus 100 can measure the thickness of the workpiece 200 even when the workpiece 200 has irregular shape, by placing the workpiece 200 between the measuring elements 40. The measurement is automatically operated by lasers, which takes less time and improves measurement results.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A measuring apparatus, comprising:
a supporting column;
a securing assembly movably located on the supporting column at a predetermined height; and
a pair of measuring elements secured on the securing assembly opposite to each other, the measuring elements emitting lasers to opposite sides of a workpiece positioned in a space therebetween and detecting the lasers reflected by opposite sides of the workpiece;
wherein the measuring apparatus includes a control unit that calculates a time that each laser travels and determines a width of the workpiece based on the time.

2. The measuring apparatus as claimed in claim 1, wherein the supporting column defines a mounting groove and a hole on one surface, the mounting groove is defined lengthwise, the hole is defined adjacent to the mounting groove.

3. The measuring apparatus as claimed in claim 2, wherein the securing assembly comprises a fixing board, the fixing board defines a slot and a pair of mounting holes, the slot is aligned to the mounting groove, each mounting hole is defined on an opposite end of the slot and is engaged with the mounting groove to mount the fixing board to the mounting groove.

4. The measuring apparatus as claimed in claim 3, wherein the fixing board can move relative to the mounting groove and then secured via the mounting holes and the mounting groove, thereby a height of the securing assembly can be adjusted.

5. The measuring apparatus as claimed in claim 3, wherein the securing assembly further comprises a pair of connecting boards and a pair of strengthening boards, each connecting board is connected to an opposite end of the fixing board and extend perpendicularly from the fixing board, each strengthening board is connected to one of the connecting boards.

6. The measuring apparatus as claimed in claim 5, wherein each strengthening board is substantially a right-angle triangle and has a side lay on the connecting board and another side lean on the fixing board.

7. The measuring apparatus as claimed in claim 5, wherein the securing assembly further comprises a first securing board and a second securing board, the first securing board is substantially L-shaped and includes a horizontal portion and a longitudinal portion, the horizontal portion is connected to one end of the connecting board away from the fixing board, the longitudinal portion is perpendicularly connected to the horizontal portion and defines a securing groove, the securing groove is defined longitudinally.

8. The measuring apparatus as claimed in claim 7, wherein the second securing board is substantially an L and defines a pair of securing holes on opposite ends, one side of the second securing board is connected to the other connecting board, the second securing board is opposite to the first securing board.

9. The measuring apparatus as claimed in claim 8, wherein each measuring element defines a pair of fixing holes on opposite ends, the fixing holes of one measuring element and engaged with the securing holes of the second securing board to secure one of the measuring element to the second securing board; the fixing holes of the other measuring element are engaged with the securing groove of the first securing board to secure the other measuring element to the first securing board.

10. The measuring apparatus as claimed in claim 9, wherein the measuring element can move relative to the securing groove and then being secured via the fixing holes and the securing groove, thereby a distance between the measuring elements can be adjusted.

11. The measuring apparatus as claimed in claim 10, further comprising a control box, wherein the supporting column is located on the control box, the control box comprises the control unit, the measuring elements are electrically connected to the control unit, the control unit further electrically connects to a computer, the measuring elements can transmit measuring data to the computer via the control unit.

12. The measuring apparatus as claimed in claim 11, wherein the hole of the supporting column is for having cables connecting the measuring elements and the control unit inserted therethrough.

13. The measuring apparatus as claimed in claim 12, wherein each measuring element includes a laser source element for emitting laser and a laser detector for detecting laser, the measuring elements receive a workpiece in a space therebetween, the laser source element of each measuring element emits laser to the workpiece, the laser emitted by the measuring element reaches to a surface of the workpiece, then is reflected and travels a return trip from the surface of the workpiece to the measuring element, the laser detector of the corresponding measuring element receives the laser; the measuring element records a time of the laser from transmitted to received, the computer calculates a first distance between the measuring element and the surface of the workpiece according to the recorded time and a velocity of laser.

14. The measuring apparatus as claimed in claim 13, wherein the other measuring element measures a second distance in a space therebetween with another surface of the workpiece, the computer calculates a thickness of the workpiece according to a total distance of the measuring elements minus the first distance and the second distance.
